(19) United States
(12) Patent Application Publication
(10) Pub. No.: US 2026/0288357 A1
(43) Pub. Date: Sep. 24, 2026

(54) STORAGE SYSTEM AND STORAGE SYSTEM CONTROL METHOD

(71) Applicant: Hitachi Vantara, Ltd., Kanagawa-ken (JP)

(72) Inventors: Koji HOSOGI, Tokyo (JP); Mutsumi HOSOYA, Tokyo (JP); Takahiro YAMAMOTO, Tokyo (JP); Norio SHIMOZONO, Tokyo (JP)

(21) Appl. No.: 19/324,705

(22) Filed: Sep. 10, 2025

(30) Foreign Application Priority Data
Mar. 24, 2025 (JP) 2025-048945

(51) Int. Cl. G06F 3/06

(52) U.S. Cl. CPC G06F 3/0647; G06F 3/0611; G06F 3/0644; G06F 3/0659; G06F 3/0665; G06F 3/067

(57) ABSTRACT

A second storage of a storage system including a first storage and the second storage stores data in a storage pool correspondingly to a plurality of physical drives having different costs and performance. The second storage migrates the data between the plurality of physical drives having different costs and performance according to a state of an application using the data.

### CROSS REFERENCE TO RELATED APPLICATION

This application relates to and claims the benefit of priority from Japanese Patent Application number 2025-048945, filed on Mar. 24, 2025 the entire disclosure of which is incorporated herein by reference.

### BACKGROUND OF THE INVENTION

### 1. Field of the Invention

The present invention relates to a storage system and a storage system control method.

### 2. Description of Related Art

In recent years, there has been a demand for hybrid cloud processing in which data and applications are migrated or linked between on-premises and cloud. For example, there is a mode in which a primary site program such as an online transaction operating on on-premises (primary site) generates data, and secondary usage such as data utilization is executed on a cloud side (secondary site) using a result of the processing. In a general block storage, volume data of a primary site is statically copied to a volume of a secondary site in advance, and secondary usage processing of the secondary site is executed by accessing the copied volume.

Further, a technique using a virtualization technique as described in PTL 1 is disclosed. In the technique, a snapshot volume of a primary site in which a data entity is stored is associated with a virtual volume of a secondary site. For each read I/O request issued by an application of the secondary site, in an initial state, data is read from the snapshot volume of the primary site, the data is stored in the virtual volume, and the data is returned to the application. On the other hand, when an address indicated by a next I/O request is previously stored in the virtual volume, a cache-like operation of returning data from the virtual volume is performed. As described above, in the technique disclosed in PTL 1, dynamic and partial data replication is performed in conjunction with an application that operates at a higher order.

### CITATION LIST

### Patent Literature

PTL 1: JP2024-098944A

### SUMMARY OF THE INVENTION

Here, it is assumed that a cloud is allocated to the secondary site. There are a plurality of types of data stores in the cloud. For example, there are a performance priority data store that is good at high-speed access and a cost priority data store that is low in cost per capacity and with low-speed access. The performance and the cost are in a trade-off relationship, and the low cost is further achieved by selectively using these two types of data stores.

However, in the technique disclosed in PTL 1, since this selective use is not performed, the balance between the performance and the cost is poor. For example, when the performance priority data store is always used, there is a problem that the cost increases. Such a problem occurs not only when the primary site is on-premises and the secondary site is a cloud, but also when backup of data of the storage system is performed.

The invention has been made in view of the above problems, and an object thereof is to achieve both high performance and low cost in data backup of a storage system.

In order to achieve the above object, there is provided a storage system according to an aspect of the invention. The storage system includes a first storage and a second storage. Each of the first storage and the second storage includes a physical drive configured to physically store data, a storage pool formed based on a storage area of the physical drive, a logical volume mapped to the storage pool and provided as a request destination of an I/O request, a memory, and a processor. The first storage includes a first logical volume. The second storage includes a second logical volume corresponding to the first logical volume. The second storage stores the data in the storage pool correspondingly to a plurality of the physical drives having different costs and performance with each other, and migrates the data between the plurality of the physical drives having different costs and performance according to a state of an application using the data.

According to the invention, for example, it is possible to achieve both high performance and low cost in data backup of a storage system.

### BRIEF DESCRIPTION OF THE DRAWINGS

FIG. 1 is a block diagram illustrating a configuration example of a hybrid cloud system according to an embodiment.

FIG. 2 is a block diagram illustrating a hardware structure example of a first storage system and a second storage system according to the embodiment.

FIG. 3 is a logical image diagram illustrating a storage function of the first storage system according to the embodiment.

FIG. 4 is a logical image diagram illustrating a storage function of the second storage system according to the embodiment.

FIG. 5 is a diagram illustrating data held in a memory in the storage system according to the embodiment.

FIG. 6 illustrates a pool management table according to the embodiment.

FIG. 7 illustrates a volume management table according to the embodiment.

FIG. 8A is a diagram illustrating a volume control method in a performance priority mode (High Performance), which is one operation mode of a virtual volume according to the embodiment.

FIG. 8B is a diagram illustrating the volume control method in a middle-1 mode (Middle-1), which is one operation mode of the virtual volume according to the embodiment.

FIG. 8C is a diagram illustrating a volume control method in a middle-2 mode (Middle-2), which is one operation mode of the virtual volume according to the embodiment.

FIG. 8D is a diagram illustrating a volume control method in a cost priority mode (Low Cost), which is one operation mode of the virtual volume according to the embodiment.

FIG. 9 illustrates a state (P-State) of page data stored in each pool according to the embodiment.

FIG. 10 illustrates a logical-to-physical conversion table that holds data storage positions according to the embodiment.

FIG. 11 is a diagram illustrating a function of a logical-to-physical allocation unit according to the embodiment.

FIG. 12 is a flowchart illustrating read I/O processing according to the embodiment.

FIG. 13 is a flowchart illustrating write I/O processing according to the embodiment.

FIG. 14 illustrates backup processing according to the embodiment.

FIG. 15 is a flowchart illustrating collective restore processing according to the embodiment.

### DESCRIPTION OF EMBODIMENTS

Hereinafter, embodiments according to the invention will be described in details with reference to the drawings. The following description and drawings are examples for describing the invention and are omitted and simplified as appropriate for clarity of description. Not all combinations of features described in the embodiment are essential to the solution of the invention. The invention is not limited to the embodiments, and any application example that matches the idea of the invention is within the technical scope of the invention. Those skilled in the art can make various additions and modifications to the invention within the scope of the invention. The invention can be implemented in various other forms. Unless otherwise specified, each component may be single or plural.

### Configuration of Hybrid Cloud System S

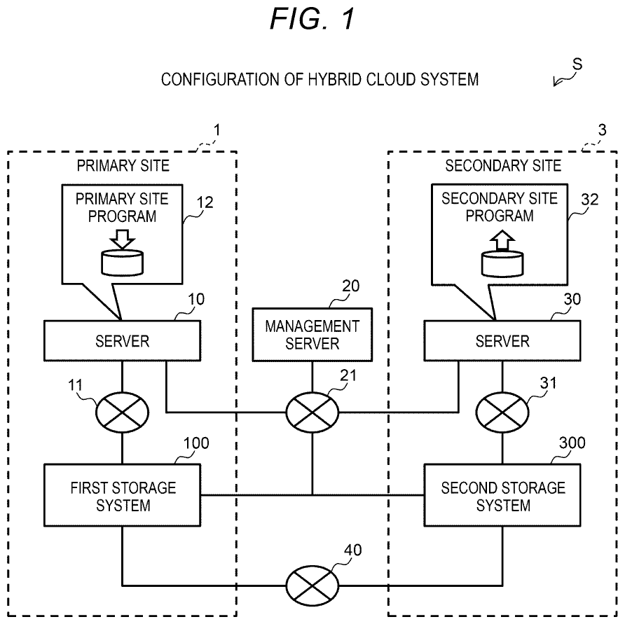

FIG. 1 is a block diagram illustrating a configuration example of a hybrid cloud system S according to an embodiment. In the hybrid cloud system S, a primary site 1, a secondary site 3, and a management server 20 that manages these sites are connected via a network 21. In the hybrid cloud system S, the primary site 1 and the secondary site 3 are connected via the network 21 in order to perform data transfer between the primary site 1 and the secondary site 3. The primary site 1 is an on-premises environment, and the secondary site 3 is a cloud environment.

In the primary site 1, a server 10 and a first storage system 100 (first storage) are connected via a network 11. The server 10 is a server that executes a primary site program 12, and the first storage system 100 stores primary-site-side data and controls I/O issued by the server 10.

In the secondary site 3, a server 30 and a second storage system 300 (second storage) are connected via a network 31. The server 30 is a server that executes a secondary site program 32, and the second storage system 300 stores cloud-side data and controls I/O issued by the server 30.

The management server 20 is connected to the server 10, the first storage system 100, the server 30, and the second storage system 300 via the network 21. The management server 20 executes initial setting and management of the connected servers 10 and 30 and storage systems (the first storage system 100 and the second storage system 300). Setting and management functions thereof may be substituted by an infrastructure management function or a deployment automation function of Kubernetes (registered trademark). The management server 20 is installed in one or both of the primary site 1 and the secondary site 3, and integrally manages the primary site 1 and the secondary site 3. The management server 20 integrally manages connected resources, and in the embodiment, an installation location and a hierarchical structure thereof are not limited.

The first storage system 100 and the second storage system 300 are connected with each other via a network 40. The network 40 serves as a data transfer path between the first storage system 100 and the second storage system 300.

### Hardware Structure of First Storage System 100 and Second Storage System 300

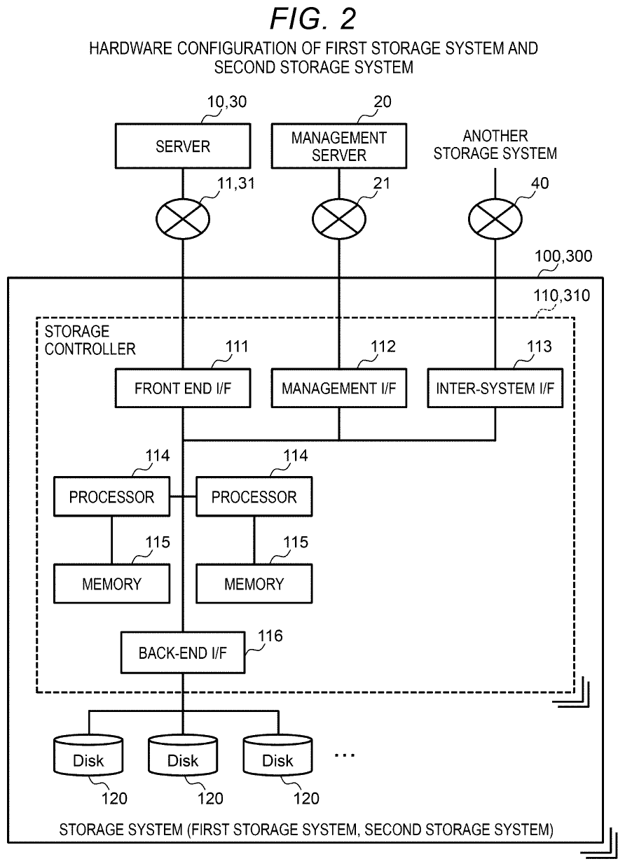

FIG. 2 is a block diagram illustrating a hardware structure example of the first storage system 100 and the second storage system 300 according to the embodiment. Although a general configuration will be described for ease of description here, the invention is not limited thereto. For example, when a storage system is implemented using cloud resources of the secondary site 3, each element can be replaced with a corresponding service provided by a cloud vendor. In the description with reference to FIG. 2, a storage function is implemented by software processing using a processor 114 and a memory 115.

Each of the first storage system 100 and the second storage system 300 includes a first storage controller 110 and a plurality of disks 120. In the first storage controller 110, a plurality of processors 114, a plurality of memories 115, a front-end I/F 111 that is an I/O interface issued by the server 10 and the server 30, and a back-end I/F 116 that is an interface of the disks 120 are connected.

A storage function such as general I/O processing is executed via the back-end I/F 116. A management I/F 112 is an interface with the management server 20. An inter-system I/F 113 is connected to another storage system via the network 40, and serves as a data transfer path between the first storage system 100 and the second storage system 300.

The first storage system 100 and the second storage system 300 have the same hardware structures, and may have different hardware structures.

### Storage Function of First Storage System 100

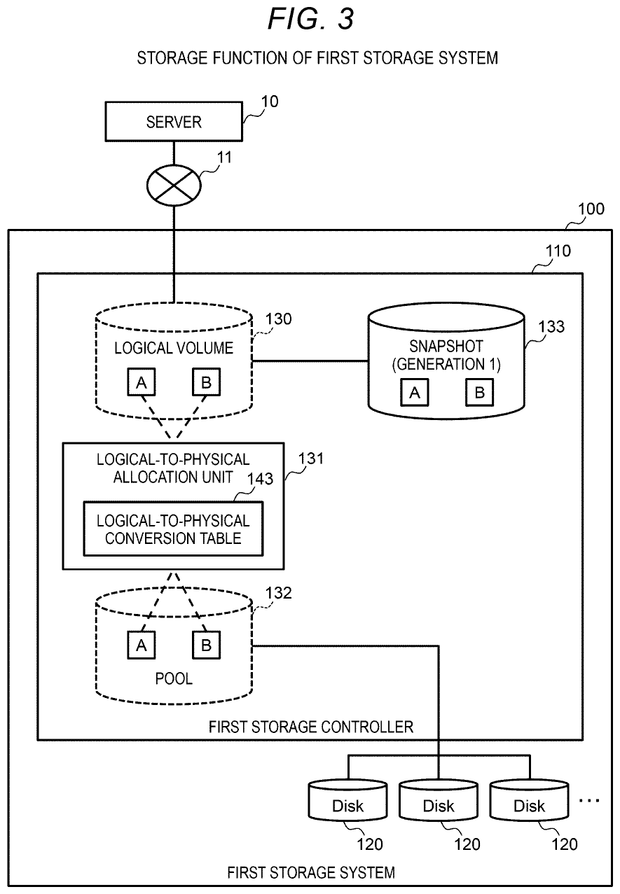

FIG. 3 is a logical image diagram illustrating a storage function of the first storage system 100 according to the embodiment.

The first storage system 100 includes the first storage controller 110 and the disk 120. In the first storage controller 110, a logical volume 130 and a pool 132 are arranged. The logical volume 130 is not a data entity but a virtual volume indicating a data storage position, and the pool 132 virtualizes a data space of the disk 120 that physically stores data.

The first storage controller 110 maps the logical volume 130 and the disk 120 using a logical-to-physical conversion table 143 of a logical-to-physical allocation unit 131. For example, a specific block of the disk 120 in the pool 132 is allocated to a logical block A in the logical volume 130 by mapping using the logical-to-physical conversion table 143 of the logical-to-physical allocation unit 131, and the logical block A is physically held in the disk 120. The server 10 can access actual data in the disk 120 by mapping using the logical-to-physical conversion table 143. The logical-to-physical conversion table 143 is copied at a designated timing and held as a snapshot 133.

### Storage Function of Second Storage System 300

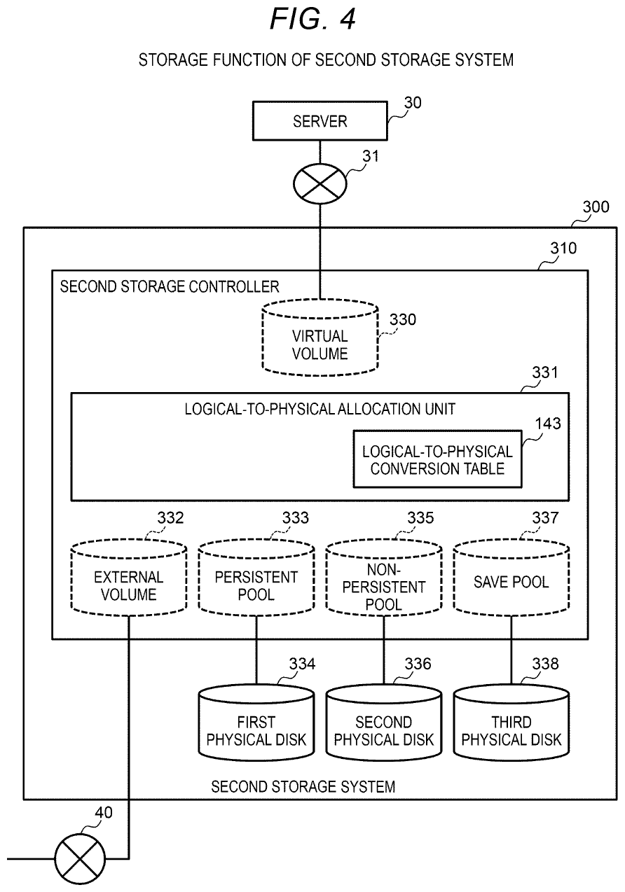

FIG. 4 is a logical image diagram illustrating a storage function of the second storage system 300 according to the embodiment.

The second storage system 300 includes a second storage controller 310, a first physical disk 334, a second physical disk 336, and a third physical disk 338. In the second storage system 300, a virtual volume 330, an external volume 332, a persistent pool 333, a non-persistent pool 335, a save pool 337 (backup pool), and a logical-to-physical allocation unit 331 are provided. The physical disk is also referred to as a physical drive.

The virtual volume 330 is a virtual logical volume indicating a data storage position. The external volume 332 is associated with the snapshot 133 illustrated in FIG. 3. The persistent pool 333 virtualizes a data space of the first physical disk 334. The non-persistent pool 335 virtualizes a data space of the second physical disk 336. The save pool 337 virtualizes a data space of the third physical disk 338. The persistent pool 333, the non-persistent pool 335, and the save pool 337 are examples of storage pools formed based on storage areas of physical drives.

The logical-to-physical allocation unit 331 maps the virtual volume 330 to the first physical disk 334, the second physical disk 336, and the third physical disk 338.

The persistent pool 333 is a storage pool in which a storage state of an entity of data stored in an area secured on the first physical disk 334 is made persistent. The non-persistent pool 335 is a storage pool in which a storage state of an entity of data stored in an area secured on the second physical disk 336 is not made persistent by release processing of this area.

The persistent pool 333 and the non-persistent pool 335 are configurations having high availability by using a technique such as data redundancy. The save pool 337 is a configuration having high availability due to data redundancy or the like but using a low-cost data store as compared with the persistent pool 333 and the non-persistent pool 335.

In the embodiment, performance of a data store (physical disk) is, for example, availability, a data access speed, and input/output per second (IOPS) of the data store. A cost of the data store (physical disk) is, for example, a product price of the data store and a cost for introduction and operation. Therefore, a term “performance priority” in the embodiment means that higher availability, data access speed, IOPS, and the like of the data store are prioritized over a lower product price of the data store, cost for introduction and operation, and the like. A term “cost priority” in the embodiment means that a lower product price of the data store, cost for introduction and operation, and the like are prioritized over higher availability, data access speed, IOPS, and the like of the data store.

The logical-to-physical allocation unit 331 includes the logical-to-physical conversion table 143 for indicating a mapping state to the first physical disk 334, the second physical disk 336, and the third physical disk 338. Details of the logical-to-physical conversion table 143 will be described later.

### Information Stored in Memories of First Storage System 100 and Second Storage System 300

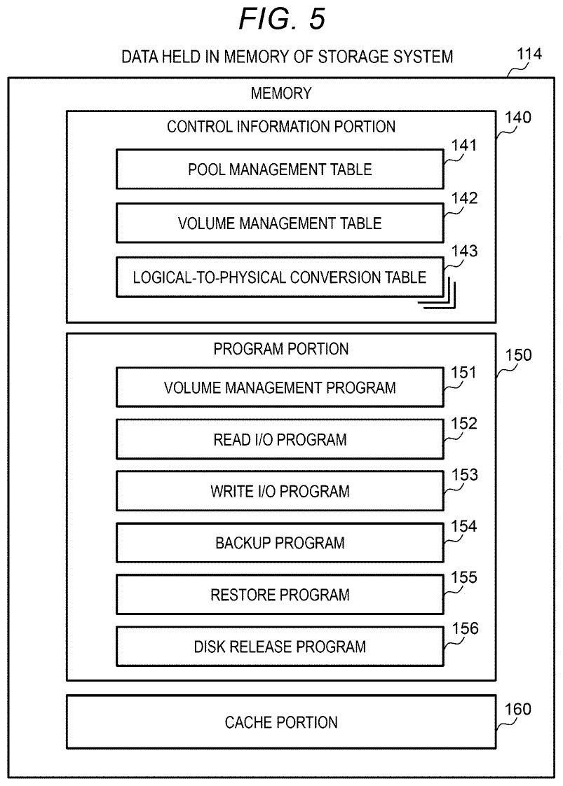

FIG. 5 is a diagram illustrating data held in the memory 115 in the storage system (the first storage system 100 and the second storage system 300)) according to the embodiment.

The memory 115 roughly stores three types, that is, a control information portion 140, a program portion 150, and a cache portion 160. The control information portion 140 includes a flag, an address, and the like for performing storage control. The program portion 150 is software in which storage control contents are programmed. The cache portion 160 temporarily holds data related to I/O in order to improve I/O performance. The cache portion 160 is a cache memory of a general storage system.

The control information portion 140 includes a pool management table 141 for virtualizing a physical disk, a volume management table 142 for defining an initial state of each volume, and the logical-to-physical conversion table 143 for associating a volume with a physical disk. The logical-to-physical conversion table 143 is an example of mapping information indicating a correspondence relationship between an address of a logical volume and an address of a physical drive. One set of the logical-to-physical conversion tables 143 are defined for the volumes.

The program portion 150 includes a volume management program 151, a read I/O program 152, a write I/O program 153, a backup program 154, a restore program 155, and a disk release program 156. The volume management program 151 performs initial setting of the virtual volume 330. The read I/O program 152 performs processing in response to a read command issued by the server 30 to the second storage system 300. The write I/O program 153 performs processing in response to a write command issued by the server 30 to the second storage system 300. The backup program 154 backs up stored data from a second pool to a third pool. The restore program 155 restores the data backed up by the backup program 154.

The disk release program 156 executes physical disk release processing. In a general cloud, a cost of a physical disk is classified into a capacity charge proportional to a usage capacity and a time charge proportional to a usage time. Therefore, the charging occurs when the physical disk is allocated, and the charging ends when the physical disk is released. Therefore, a low cost can be achieved by actively releasing the physical disk.

The disk release program 156 executes physical disk release processing using the pool management table 141. In physical disks (identified by a disk ID) defined in the pool management table 141, a disk whose Active flag is False is unused, and False indicates a state in which valid data does not exist. Therefore, when all the Active flags of the same physical disk are False, the disk release program 156 releases the physical disk. Here, the disk release program 156 operates starting from a start command issued by the management server 20 or an inline start command issued by the server 30.

### Pool Management Table 141

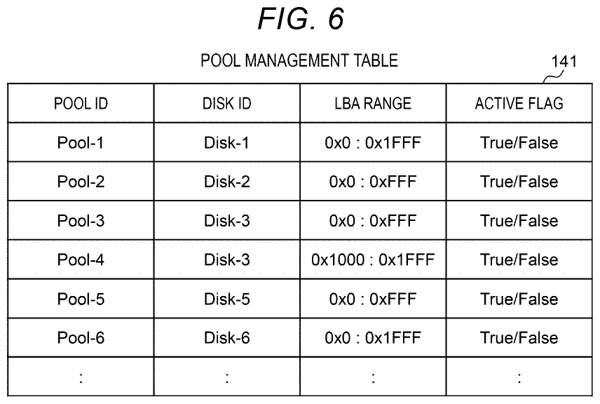

FIG. 6 illustrates the pool management table 141 according to the embodiment.

The pool management table 141 is a table that associates a plurality of pools with physical disks, and includes information such as a pool ID, a disk ID, an LBA range, and an Active flag. For example, an LBA range “0x0:0x1FFF” of a disk ID “Disk-1”, which is a physical disk, is allocated to a pool ID “Pool-1”. An LBA range “0x0:0xFFF” of a disk ID “Disk-2” is allocated to a pool ID “Pool-2”.

A single physical disk can be divided and allocated to a plurality of pools. For example, the LBA range “0x0:0xFFF” of a disk ID “Disk-3” is allocated to a pool ID “Pool-3”. An LBA range “0x1000:0x1FFF” of the same disk ID “Disk-3” is allocated to a pool ID “Pool-4”. As described above, even when the total number of pools is different from the total number of disks, the physical disks can be allocated to the pools. The Active flag indicates whether there is data in a target pool by True/False.

### Volume Management Table 142

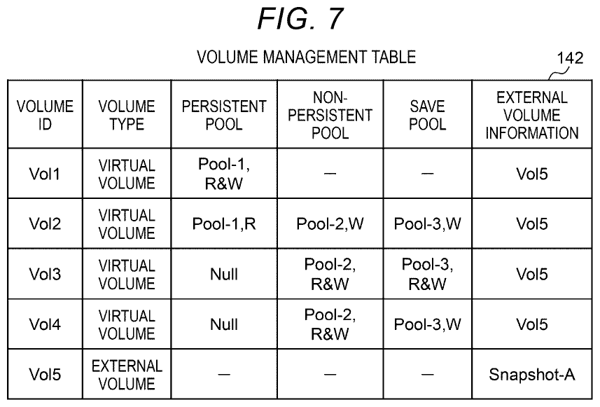

FIG. 7 illustrates the volume management table 142 according to the embodiment.

The volume management table 142 holds information for associating a volume with a pool or an external volume. The volume management table 142 includes at least a volume ID field, a volume type field, a persistent pool field, a non-persistent pool field, a save pool field, and an external volume information field.

The volume ID field is an identification ID of a target volume. The volume type field indicates whether the target volume is a virtual volume or an external volume. The persistent pool field indicates an ID of a persistent pool associated with the target volume and a storage mode thereof. The non-persistent pool field indicates an ID of a non-persistent pool associated with the target volume and a storage mode thereof. The save pool field indicates an ID of a save pool associated with the target volume and a storage mode thereof. The external volume information field indicates an ID of a virtual volume associated with the target volume.

The storage mode includes three types, that is, “R” indicating only read, “W” indicating only write, and “R & W” indicating read and write. When a target pool is the persistent pool 333 or the non-persistent pool 335, the storage mode is “R”, and the command issued by the secondary site program 32 is read, a target data storage destination is allocated to the pool. Similarly, when the target pool is the persistent pool 333 or the non-persistent pool 335, the storage mode is “W”, and the command issued by the secondary site program 32 is write, the target data storage destination is allocated to the corresponding pool. A case where the target pool is the save pool 337 will be described later.

### Basic Operations Related to Virtual Volume Control of Embodiment

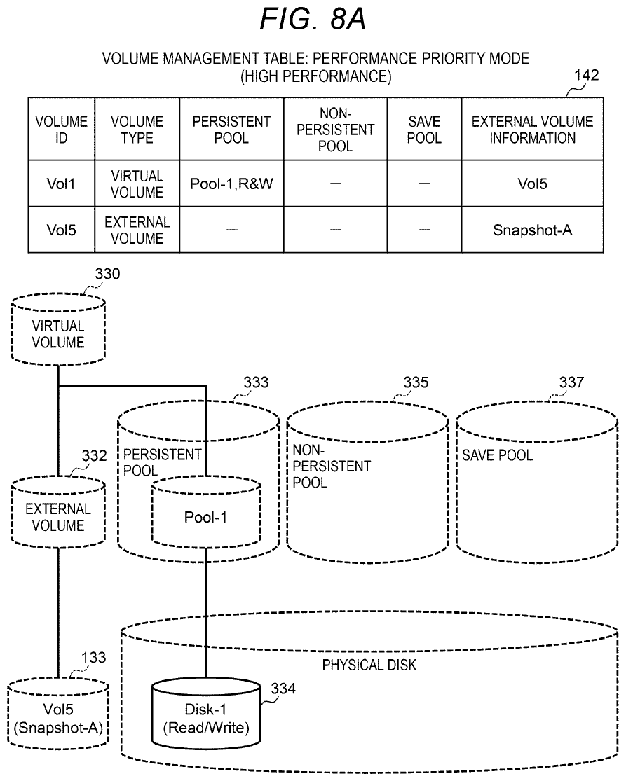

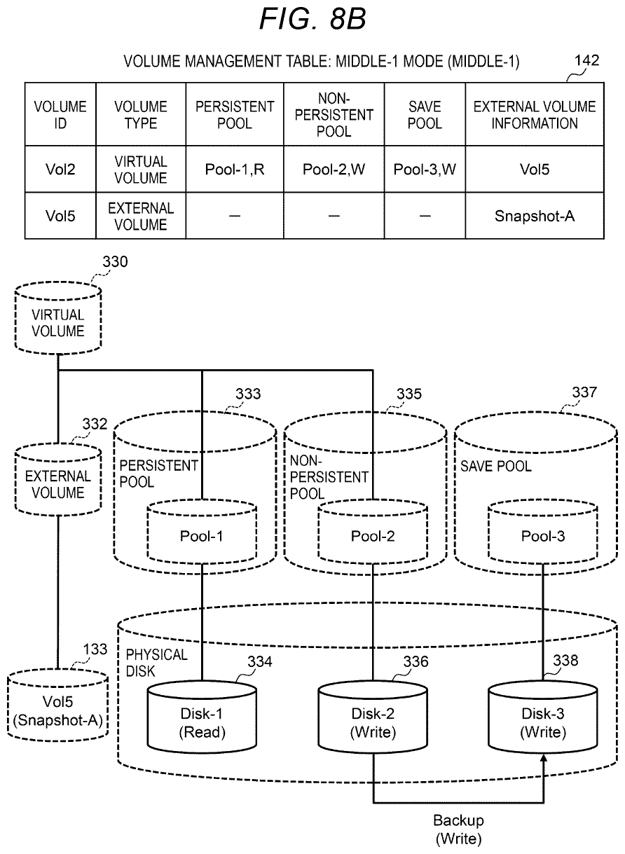

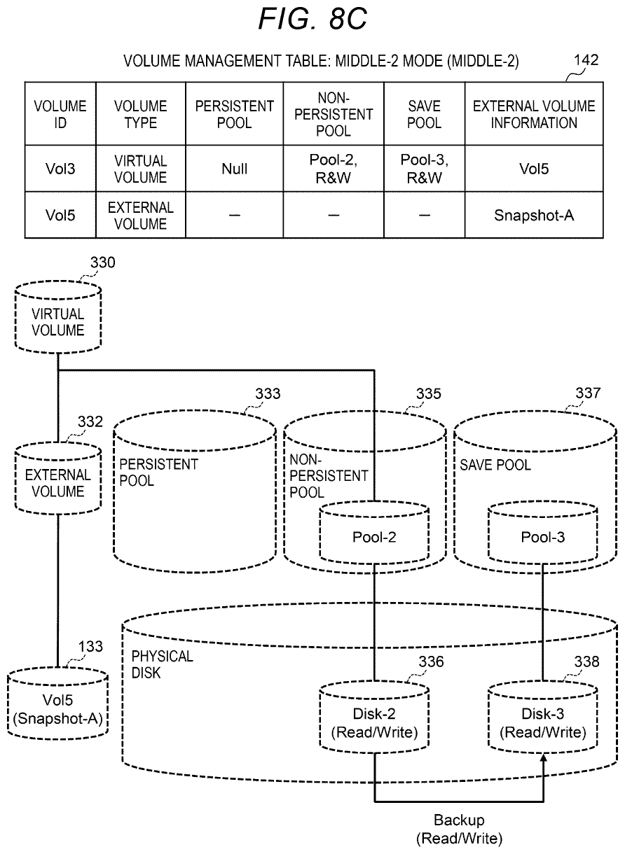

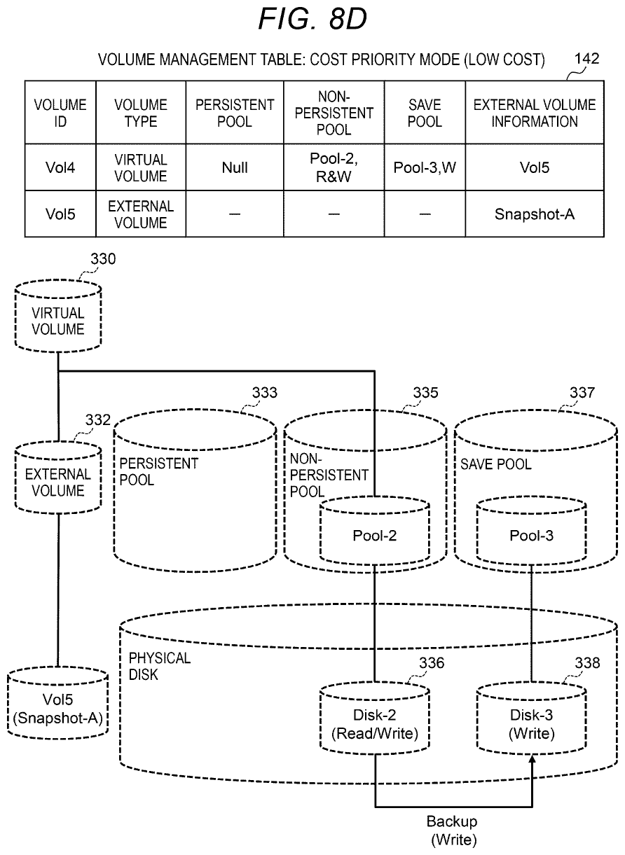

Next, basic operations related to virtual volume control of the embodiment will be described with reference to FIGS. 8A, 8B, 8C, and 8D. In the order of FIG. 8A, FIG. 8B, FIG. 8C, and FIG. 8D, the usage form transitions from performance priority to cost priority. In the description of FIGS. 8A to 8D, it is assumed that the first physical disk 334 and the second physical disk 336 use a performance priority data store, and the third physical disk 338 uses a cost priority data store.

Virtual Volume Control in Performance Priority Mode

FIG. 8A is a diagram illustrating a volume control method in a performance priority mode (High Performance), which is one operation mode of the virtual volume 330 according to the embodiment.

The virtual volume 330 (volume ID: Vol1) in the performance priority mode is associated with the persistent pool 333 with the first physical disk 334 having the storage mode of “R & W”. The external volume 332 (volume ID: Vol5) is associated with the virtual volume 330 (volume ID: Vol1). The snapshot 133 (snapshot: Snapshot-A) in the first storage system 100 is associated with the external volume 332 (volume ID: Vol5). Further, the non-persistent pool 335 and the save pool 337 are not associated with the virtual volume 330 (volume ID: Vol1).

In the performance priority mode, both read and write commands issued by the secondary site program 32 are allocated to the persistent pool 333 corresponding to the performance priority mode. As described above, in the performance priority mode, data is stored in a high-cost performance priority data store.

### Virtual Volume Control in Middle-1 Mode

FIG. 8B is a diagram illustrating a volume control method in a middle-1 mode (Middle-1), which is one operation mode of the virtual volume 330 according to the embodiment.

The virtual volume 330 (volume ID: Vol2) in the middle-1 mode is associated with the persistent pool 333 with the first physical disk 334 having the storage mode of “R”. The non-persistent pool 335 is associated with the virtual volume 330 (volume ID: Vol2) with the second physical disk 336 having the storage mode of “W”. The save pool 337 (volume ID: Vol3) is associated with the virtual volume 330 (volume ID: Vol2) with the third physical disk 338 having a storage mode of “W”.

The external volume 332 (volume ID: Vol5) is associated with the virtual volume 330 (volume ID: Vol2). The snapshot 133 (snapshot:Snapshot-A) in the first storage system 100 is associated with the external volume 332 (volume ID: Vol5).

In the middle-1 mode, the first physical disk 334, which is a data store corresponding to the performance priority mode in the persistent pool 333, is allocated in response to a read command issued by the secondary site program 32. The second physical disk 336, which is a data store corresponding to the performance priority mode in the persistent pool 333, is allocated in response to a write command issued by the secondary site program 32. As described above, while the secondary site program 32 is operating, data is stored in the performance priority data store in both read and write.

On the other hand, when the secondary site program 32 is not in operation, data is backed up from the second physical disk 336 in the non-persistent pool 335 to the third physical disk 338 in the save pool 337 implemented by the data store corresponding to the cost priority mode. The backup is executed by the backup program 154. The second physical disk 336 is released after the backup is completed.

Since only write data is stored in the non-persistent pool 335, only the write data is a backup target, and read data is held in the persistent pool 333 implemented by the performance priority data store. Therefore, in the middle-1 mode, since the read data is stored in the high-cost performance priority data store and the write data is stored in the cost priority data store, the cost is lower than that in the above-described performance priority mode.

### Virtual Volume Control in Middle-2 Mode

FIG. 8C is a diagram illustrating a volume control method in a middle-2 mode (Middle-2), which is one operation mode of the virtual volume 330 according to the embodiment.

The virtual volume 330 (volume ID: Vol3) in the middle-2 mode is not allocated to the persistent pool 333. The non-persistent pool 335 is associated with the virtual volume 330 (volume ID: Vol3) with the second physical disk 336 having a storage mode of “R & W”. Further, the save pool 337 is associated with the virtual volume 330 (volume ID: Vol3) with the third physical disk 338 having a storage mode of “R & W”.

The external volume 332 (volume ID: Vol5) is associated with the virtual volume 330 (volume ID: Vol3). The snapshot 133 in the first storage system 100 is associated with the external volume 332 (volume ID: Vol5).

In the middle-2 mode, the second physical disk 336, which is a data store corresponding to the performance priority mode in the non-persistent pool 335, is allocated regardless of the read command and the write command issued by the secondary site program 32. Therefore, when the secondary site program 32 operates, data is stored in the data store corresponding to the performance priority mode in both read and write.

On the other hand, when the secondary site program 32 is not in operation, data is backed up from the second physical disk 336 in the non-persistent pool 335 to the third physical disk 338 in the save pool 337 implemented by the data store corresponding to the cost priority mode. The backup is executed by the backup program 154. The second physical disk 336 is released after the backup is completed.

That is, in the middle-2 mode, since both the read data and the write data are stored in the cost priority data store, the cost in the middle-2 mode is lower than that in the middle-1 mode.

### Virtual Volume Control in Cost Priority Mode

FIG. 8D is a diagram illustrating a volume control method in a cost priority mode (Low Cost), which is one operation mode of the virtual volume 330 according to the embodiment.

The virtual volume 330 (volume ID: Vol4) in the cost priority mode is not allocated to the persistent pool 333. The non-persistent pool 335 is associated with the virtual volume 330 (volume ID: Vol4) with the second physical disk 336 having a storage mode of “R & W”. The save pool 337 is associated with the virtual volume 330 (volume ID: Vol4) with the third physical disk 338 having a storage mode of “W”.

The external volume 332 (volume ID: Vol5) is associated with the virtual volume 330 (volume ID: Vol4). The snapshot 133 in the first storage system 100 is associated with the external volume 332 (volume ID: Vol5).

In the cost priority mode, as in the middle-2 mode, the second physical disk 336, which is a data store corresponding to the performance priority mode in the non-persistent pool 335, is allocated regardless of the read command and the write command issued by the secondary site program 32.

On the other hand, when the secondary site program 32 is not in operation, data is backed up from the second physical disk 336 in the non-persistent pool 335 to the third physical disk 338 in the save pool 337 implemented by the data store corresponding to the cost priority mode. The backup is executed by the backup program 154. Since the storage mode of the save pool 337 is “W”, the backup target is only the write data. The second physical disk 336 is released after the backup is completed.

That is, in the cost priority mode, only the write data is stored in the cost priority data store. On the other hand, since the read data is held in the snapshot 133 on the primary site side, data holding is unnecessary on the secondary site 3 side. Therefore, in the cost priority mode, the cost is the lowest compared to other modes.

### State (P-State) of Page Data Stored in Pool

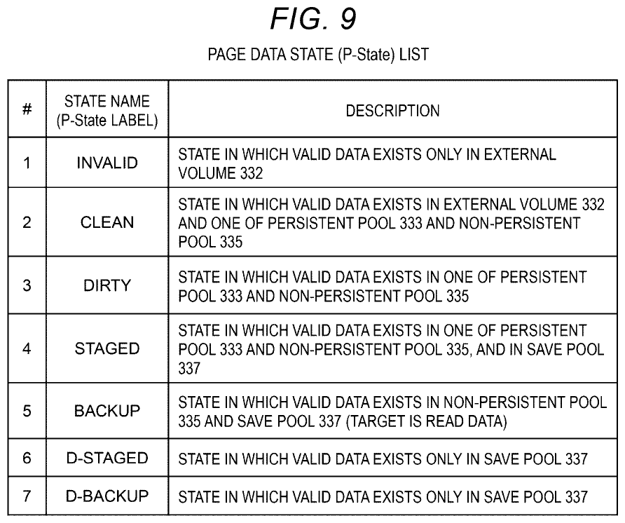

FIG. 9 is a table illustrating a state (P-State) of page data stored in each pool according to the embodiment. The P-State is given in units of data pages (data blocks) of a logical address.

A state name “INVALID” indicates a state in which valid data exists only in the external volume 332. A state name “CLEAN” indicates a state in which valid data exists in any one of the external volume 332, the persistent pool 333, and the non-persistent pool 335. A state name “DIRTY” indicates a state in which valid data exists in one of the persistent pool 333 and the non-persistent pool 335. A state name “STAGED” indicates a state in which valid data exists in one of the persistent pool 333 and the non-persistent pool 335, and the save pool 337. A state name “BACKUP” indicates a state in which valid data exists in the non-persistent pool 335 and the save pool 337. A state name “D-STAGED” indicates a state in which valid data exists only in the save pool 337. A state name “D-BACKUP” indicates a state in which valid data exists only in the save pool 337. Here, the state names “STAGED” and “BACKUP” are states for read data, and the state names “D-STAGED” and “D-BACKUP” are states for write data.

### Logical-to-physical Conversion Table 143

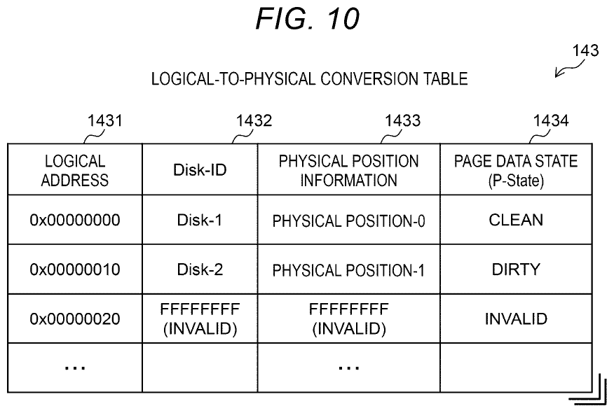

FIG. 10 illustrates the logical-to-physical conversion table 143 that holds a data storage position according to the embodiment.

The logical-to-physical conversion table 143 includes at least four fields of a logical address field 1431, a Disk-ID field 1432, a physical position information field 1433, and a page data state (P-State) 1434.

The logical address field 1431 indicates a logical address of a block device. The Disk-ID field 1432 indicates an identification number of a connected physical disk. The physical position information field 1433 indicates a physical position of the corresponding logical address in the connected physical disk. The page data state (P-State) 1434 indicates a page data state.

The physical position information field 1433 varies depending on a target physical disk. When the target physical disk is a block device such as an HDD or an SSD, the physical position information is a logical address of the block device. On the other hand, when the target physical disk is an object storage, the physical position information is an object ID. For example, a page, in which a value of the logical address field 1431 is 0x00000000, is assigned a physical position-0 in a physical disk of Disk-1, and the page data state is CLEAN. Accordingly, when a page, in which the value of the logical address field 1431 is 0x00000000, is referred to, it means that the data in the physical position-0 of the physical disk: Disk-1 is referred to.

For a page in which the value of the logical address field 1431 is 0x00000020, it is indicated that the Disk-ID 1432 and physical position information field 1433 are in an invalid state, and the page data state (P-State) 1434 is “INVALID”. Since the page data state (P-State) 1434 is “INVALID”, valid data of the logical address field 1431 exists only in the external volume 332. By using the logical-to-physical conversion table 143 in this manner, it is possible to determine, from a logical address 170, where valid data exists.

### Function of Logical-to-physical Allocation Unit 131

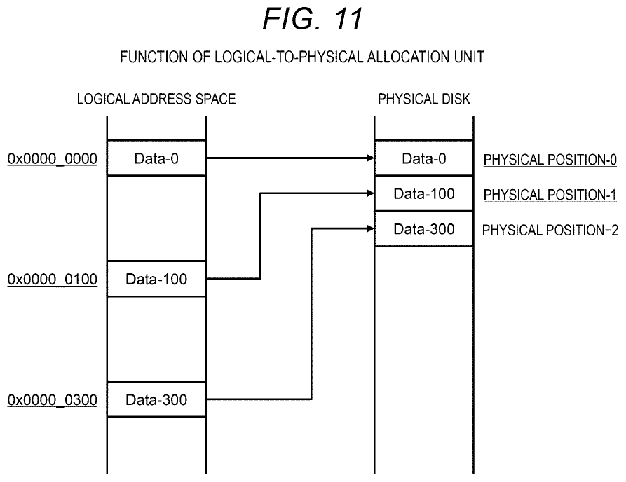

FIG. 11 is a diagram illustrating a function of the logical-to-physical allocation unit 131 according to the embodiment.

The logical-to-physical allocation unit 331 allocates a physical address of a physical disk or the like to a specified logical address. As illustrated in FIG. 11, a logical address 0x0000_0000 is allocated to the physical position-0 of the physical disk, a logical address 0x0000_0100 is allocated to a physical position-1 of the physical disk, and a logical address 0x0000_0300 is allocated to a physical position-2 of the physical disk. Since the logical address and the physical address are allocated so as to be different from each other, a large-capacity logical address space can be allocated to a small-capacity physical address space, and the capacity of the physical disk actually required can be reduced. The method of allocating the physical address to the logical address is not limited to the above.

### Processing According to Embodiment

Next, an example of a processing program executed by the second storage controller 310 will be described. As illustrated in FIG. 5, the processing program includes at least the volume management program 151, the read I/O program 152, the write I/O program 153, the backup program 154, and the restore program 155.

The volume management program 151 is a program for performing volume association using the volume management table 142 shown in FIG. 7. First, when the virtual volume 330 is generated from the beginning, the volume management program 151 sets the volume ID of the virtual volume 330 as shown in each row of the volume management table 142. Then, the volume management program 151 associates each pool with the physical disk, and associates the snapshot 133 corresponding to the external volume 332.

Next, the volume management program 151 generates one set of the logical-to-physical conversion tables 143 for the virtual volume 330. Then, as an initial state, the volume management program 151 designates the Disk-ID field 1432 and the page data state (P-State) 1434 corresponding to all logical addresses (the logical address field 1431) to “INVALID”. Thus, in the initial state, since all the logical addresses (the logical address field 1431) are “INVALID”), there is a state in which all the data exist only in the snapshot 133 on the primary site 1 side.

In the volume generation, when a new physical disk is added, the physical disk is added to the pool management table 141. In addition, in the pool management table 141, by setting “True” to the Active flags for all the pools to be used, a target pool and a target physical disk are set to an in-use state.

Here, the volume management program 151 operates starting from a start command issued from the management server 20 or an inline start command issued from the server 30.

### Read I/O Processing According to Embodiment

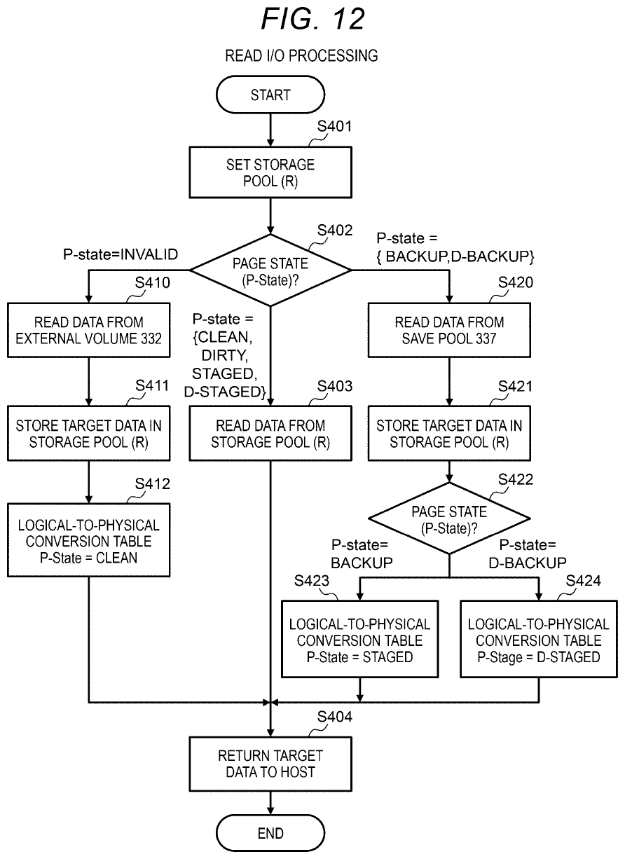

FIG. 12 is a flowchart illustrating read I/O processing according to the embodiment. The second storage controller 310 executes the read I/O processing when a command issued from the secondary site program 32 executed by the server 30 is a read command (read I/O request).

First, in step S401, the second storage controller 310 sets a storage pool (R). When the target virtual volume 330 is in the performance priority mode (corresponding to FIG. 8A) or the middle-1 mode (corresponding to FIG. 8B), the persistent pool 333 is set as the storage pool (R). When the target virtual volume 330 is in the middle-2 mode or the cost priority mode, the non-persistent pool 335 is set as the storage pool (R).

Next, in step S402, the second storage controller 310 transitions to different processing according to the page data state (P-State) of the target logical address 170 indicated in the logical-to-physical conversion table 143 determined from a logical address of the read command. If the page data state (P-State) is “INVALID”, the second storage controller 310 shifts the processing to step S410. On the other hand, the second storage controller 310 shifts the processing to S403 if the page data state (P-State) is any of “CLEAN”, “DIRTY”, “STAGED”, and “D-STAGED”. If the page data state (P-State) is either “BACKUP” or “D-BACKUP”, the second storage controller 310 shifts the processing to step S420.

In step S410, the second storage controller 310 reads target page data from the external volume 332. Next, in step S411, the second storage controller 310 stores the target data read in step S410 in a storage area secured in the storage pool (R) set in step S401. Next, in step S412, the second storage controller 310 changes the page data state (P-State) of a corresponding logical address position in the logical-to-physical conversion table 143 to “CLEAN”. Next, in step S404, the target page data is returned to a host (the server 30 that executes the secondary site program 32), and the read command is ended.

In step S403, the second storage controller 310 reads target page data from the storage pool (R) set in step S401, and shifts the processing to step S404.

In step S420, the second storage controller 310 reads target page data from the save pool 337. Next, in step S421, the second storage controller 310 stores the target page data in the storage area secured in the storage pool (R) set in step S401.

Next, in step S422, the second storage controller 310 re-determines the page data state (P-State) determined in step S402. The second storage controller 310 shifts the processing to step S423 if the page data state (P-State) is “BACKUP”, and to step S424 if the page data state (P-State) is “D-BACKUP”.

In step S423, the second storage controller 310 changes the page data state (P-State) of a corresponding logical address position in the logical-to-physical conversion table 143 to “STAGED”, and shifts the processing to step S404. On the other hand, in step S424, the second storage controller 310 changes the page data state (P-State) of a corresponding logical address position in the logical-to-physical conversion table 143 to “D-STAGED”, and shifts the processing to step S404.

When a read command is issued by the operation of the read I/O program 152, the target page data is staged to the persistent pool 333 or the non-persistent pool 335 using a performance priority data store, and high-speed access is possible at the next and subsequent access.

### Write I/O Processing According to Embodiment

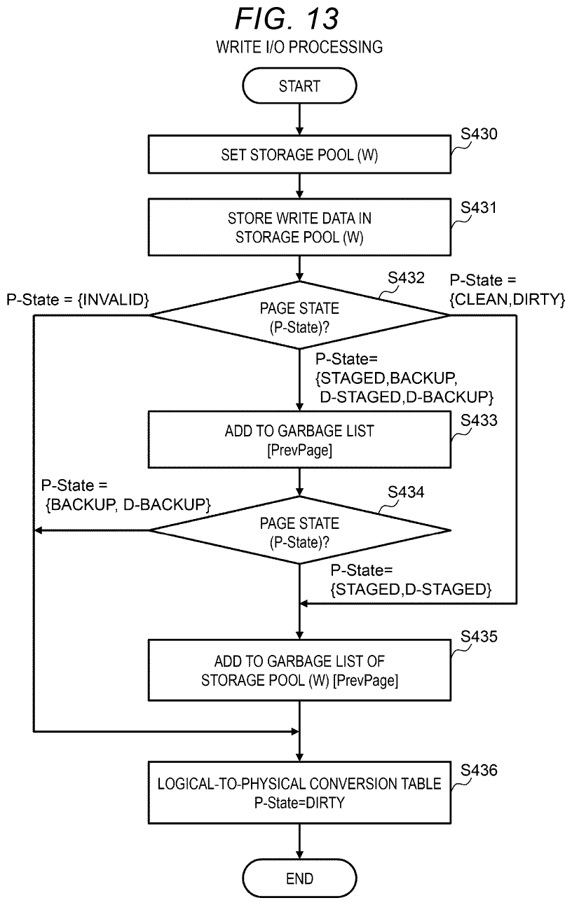

FIG. 13 is a flowchart illustrating write I/O processing according to the embodiment. The second storage controller 310 executes the write I/O processing when a command issued from the secondary site program 32 executed by the server 30 is a write command (write I/O request).

First, in step S430, the second storage controller 310 sets a storage pool (W). When the target virtual volume 330 is in the performance priority mode, the persistent pool 333 is set as the storage pool (W). When the target virtual volume 330 is in the middle-1 mode, the middle-2 mode, or the cost priority mode, the non-persistent pool 335 is set as the storage pool (W).

Next, in step S431, the second storage controller 310 stores write data in a storage area secured in the storage pool (W) set in step S430. By the operation of step S431, new data (update data) is stored in the storage pool (W), and old data is stored in any pool. Therefore, in steps S431, S433, S434, and S435, the old data is discarded.

First, in step S432, the second storage controller 310 transitions to different processing according to the page data state (P-State) of the target logical address 170 indicated in the logical-to-physical conversion table 143 determined from a logical address of the write command. If the page data state (P-State) is any of “STAGED”, “BACKUP”, “D-STAGED”, and “D-BACKUP”, the second storage controller 310 shifts the processing to step S433. On the other hand, the second storage controller 310 shifts the processing to step S435 if the page data state (P-State) is either “CLEAN” or “DIRTY”, and shifts the processing to step S436 if the page data state (P-State) is “INVALID”.

In step S433, the second storage controller 310 adds the old data stored in the save pool 337 to a garbage list for discarding the old data. Information to be added is a physical position (PrevPage) where the old data is stored in the save pool 337.

Next, in step S434, the second storage controller 310 re-determines the page data state (P-State) determined in step S432. If the page data state (P-State) is either “STARGE” or “D-STAGED”, the second storage controller 310 shifts the processing to step S435. On the other hand, if the page data state (P-State) is either “BACKUP” or “D-BACKUP”, the second storage controller 310 shifts the processing to step S436.

In step S435, since the old data is stored in the storage pool (W), the second storage controller 310 adds the old data to the garbage list for discarding the old data, and shifts the processing to step S436 when the discarding of the old data (generation of the garbage list) is completed. Next, in step S436, the second storage controller 310 changes the page data state (P-State) of the corresponding logical address position in the current logical-to-physical conversion table 143 to “DIRTY”.

When an operation mode is the cost priority mode, the read data and the write data coexist in the non-persistent pool 335, and only the write data is stored in the save pool 337 that is a backup destination. In this case, by re-mapping only the write data so as to be continuously arranged in the save pool 337, an invalid area is restricted, and an effective capacity of the save pool 337 is reduced. In particular, when the save pool 337 is configured using an object storage, the capacity charge occurs only for the allocated data capacity, and thus low cost can be achieved by re-mapping.

In the case of an object storage, an I/O charge is in proportion to the number of times of writing. Therefore, the I/O charge can be reduced by collectively writing a plurality of pieces of save data to one object. In this case, the data storage position is determined by expressing the logical-to-physical conversion table 143 by hierarchical mapping of the plurality of pieces of save data.

By the series of processing, the page data state (P-State) of the new write data becomes “DIRTY”, and the old data stored in another pool that is to be deleted is added to the garbage list. After the backup program 154 described later is executed, the old data described in the garbage list is discarded (the pool is released).

### Backup Processing According to Embodiment

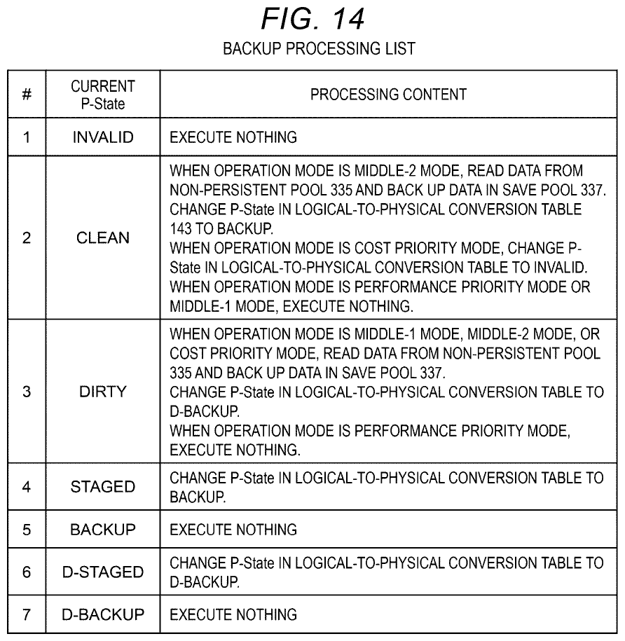

FIG. 14 illustrates operations of backup processing according to the embodiment. The backup program 154 executes backup processing starting from a start command issued from the management server 20 or an inline start command issued from the server 30.

The backup processing is executed for all the logical addresses 170 held in the logical-to-physical conversion table 143 allocated to the target virtual volume 330. When the backup processing is started, the backup program 154 extracts each row from the logical-to-physical conversion table 143 and executes processing content shown in FIG. 14.

When the current page data state (P-State) is “INVALID”, “BACKUP”, or “D-BACKUP”, the backup program 154 executes nothing.

When the current page data state (P-State) is “CLEAN”, the backup program 154 performs different processing depending on the operation mode. When the operation mode is the middle-2 mode, the backup program 154 reads data from the non-persistent pool 335 and backs up the data in the save pool 337. Then, the backup program 154 changes the page data state (P-State) of the target logical address in the logical-to-physical conversion table 143 to “BACKUP”. When the operation mode is the cost priority mode, the backup program 154 changes the page data state (P-State) of the target logical address in the logical-to-physical conversion table 143 to “INVALID”. When the operation mode is either the performance priority mode or the middle-1 mode, the backup program 154 executes nothing.

The backup program 154 reads data from the non-persistent pool 335 when the current page data state (P-State) is “DIRTY” and the operation mode is any one of the middle-1 mode, the middle-2 mode, and the cost priority mode. The backup program 154 backs up the read data in the save pool 337. Then, the backup program 154 changes the page data state (P-State) of the target logical address in the logical-to-physical conversion table 143 to “D-BACKUP”. When the operation mode is the performance priority mode, the backup program 154 executes nothing.

When the current page data state (P-State) is “STAGED”, the backup program 154 changes the page data state (P-State) of the target logical address in the logical-to-physical conversion table 143 to “BACKUP”.

When the current page data state (P-State) is “D-STAGED”, the backup program 154 changes the page data state (P-State) of the target logical address in the logical-to-physical conversion table 143 to “D-BACKUP”.

Finally, the backup program 154 changes the Active flag of a target entry in the pool management table 141 to “False” for the pool allocated to the non-persistent pool 335. By performing this series of operations on the entire logical address space, the backup processing illustrated in FIGS. 8A to 8D is implemented.

### Collective Restore Processing According to Embodiment

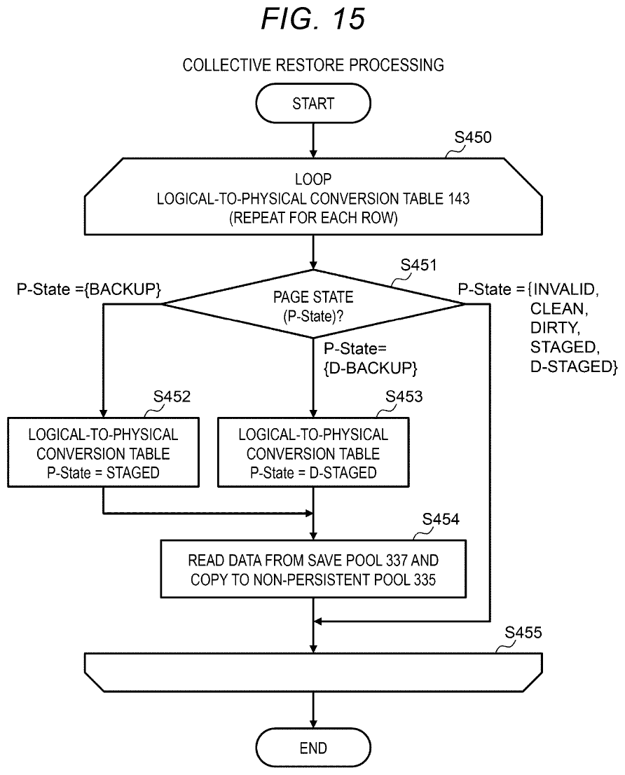

FIG. 15 is a flowchart illustrating collective restore processing according to the embodiment. The execution of data restore is triggered not only when I/O is executed for each piece of data (steps S423 and S424) but also when a high-order application that issues I/O is collectively restarted. The restore program 155 executes restore processing when executing I/O for each piece of data and executes the collective restore processing.

The second storage controller 310 of the second storage system 300 executes the processing of steps S450 to S454 for each entry in the logical-to-physical conversion table 143.

First, in step S450, the second storage controller 310 selects one unprocessed entry from the logical-to-physical conversion table 143.

Next, in step S451, the second storage controller 310 determines a current page data state (P-State) of the entry selected in step S450. If the current page data state (P-State) is “BACKUP”, the second storage controller 310 shifts the processing to step S452. If the current page data state (P-State) is “D-BACKUP”, the second storage controller 310 shifts the processing to step S453. If the current page data state (P-State) is “INVALID”, “CLEAN”, “DIRTY”, “STAGED”, or “D-STAGED”, the second storage controller 310 shifts the processing to step S455.

In step S452, the second storage controller 310 changes the current page data state (P-State) of the entry selected in step S450 to “STAGED”. When step S452 ends, the second storage controller 310 shifts the processing to step S454.

In step S453, the second storage controller 310 changes the current page data state (P-State) of the entry selected in step S450 to “D-STAGED”. When step S453 ends, the second storage controller 310 shifts the processing to step S454.

In step S454, the second storage controller 310 reads data corresponding to the entry selected in step S450 from the save pool 337 and copies the data to the non-persistent pool 335. When step S454 ends, the second storage controller 310 shifts the processing to step S455.

In step S454, the second storage controller 310 determines whether there is an entry, for which the processing of steps S451 to S455 is not performed, in the logical-to-physical conversion table 143. The second storage controller 310 returns the processing to step S450 when there is an entry, for which the processing of steps S451 to S455 is not performed, in the logical-to-physical conversion table 143, and ends the collective restore processing when there is no the entry.

### Effects of Embodiment

In the above-described embodiment, data is migrated between a plurality of physical drives having different costs and performance according to a state of an application using the data. Therefore, in a hybrid cloud storage, it is possible to migrate data between data stores of the performance priority data store and the cost priority data store according to operating and non-operating states of the high-order application using the data, thereby achieving both high performance and low cost.

In the above-described embodiment, when an application is in a state of accessing data, the data is stored in a physical drive having high cost and performance, and when the application is in a state of not accessing data, the data is stored in a physical drive having low cost and performance compared to a physical drive having high cost and performance. Therefore, in the hybrid cloud storage, it is possible to store data in the performance priority data store to prioritize data access performance when the high-order application using the data is operated, and to store data in the cost priority data store to prioritize low cost of the data store when the high-order application is not operated.

In the above-described embodiment, the second storage includes a first pool, a second pool, and a third pool in the storage pool. The first pool and the second pool correspond to physical drives having higher cost and performance than that of the third pool, and the third pool corresponds to a physical drive having lower cost and performance than those of the first pool and the second pool. Data stored in the second pool is migrated between the physical drive corresponding to the second pool and the physical drive corresponding to the third pool according to a state of an application using the data, and data stored in the first pool is not migrated between the plurality of physical drives according to the state of the application using the data. Therefore, in the hybrid cloud storage, among performance priority data stores, by providing a data store that makes the stored data persistent and a data store that backs up the stored data without making the stored data persistent, it is possible to achieve high performance while restricting an increase in cost.

Further, in the above-described embodiment, the second storage reads data from the first pool, the second pool, or the third pool mapped to a second logical volume and responds to the application in response to an I/O request from the application, and stores data in the second pool when the data is read from the third pool. Therefore, in the hybrid cloud storage, by storing the read data in the performance priority data store that does not make the stored data persistent, it is possible to achieve high performance while restricting an increase in cost.

In addition, in the above-described embodiment, first data related to the write written from the application and second data related to the read transferred from the first storage are stored in the storage pool, and a pool in which the first data and the second data are stored is defined from among the first pool, the second pool, and the third pool. Therefore, in the hybrid cloud storage, by defining the data store as a storage destination for storing the read data and the write data according to a mode related to the performance and cost, it is possible to achieve high performance while restricting an increase in cost.

Further, in the above-described embodiment, the second data is stored in the second pool, and when the application is in a state of not accessing the data, the second data is deleted instead of being migrated to the third pool, and after the application is in a state of accessing the data after the deletion of the second data, the deleted second data is transferred from the first storage to the second storage and stored in the second pool. Therefore, in the hybrid cloud storage, it is possible to achieve high performance while restricting an increase in cost regarding the storage of read data in the data store.

In the above-described embodiment, the physical drive having low cost and performance corresponding to the third pool is an object storage. Therefore, a further low cost can be achieved in the hybrid cloud storage.

Although some embodiments have been described above, these embodiments are examples for describing the invention, and the scope of the invention is not limited to these embodiments. The invention can be implemented in various other forms, for example, a form in which a part of the configuration of each of the above-described embodiments is deleted, a form in which at least a part of the configuration is replaced, a form in which a configuration is added, and a form in which a part or all of the embodiments are combined.

What is claimed is:

1. A storage system comprising:
a first storage; and
a second storage, wherein
each of the first storage and the second storage includes
a physical drive configured to physically store data,
a storage pool formed based on a storage area of the physical drive,
a logical volume mapped to the storage pool and provided as a request destination of an I/O request,
a memory, and
a processor,
the first storage includes a first logical volume,
the second storage includes a second logical volume corresponding to the first logical volume, and
the second storage
stores the data in the storage pool correspondingly to the plurality of physical drives having different costs and performance with each other, and
migrates the data between the plurality of physical drives having different costs and performance according to a state of an application using the data.

2. The storage system according to claim 1, wherein
when the application is in a state of accessing the data, the data is stored in the physical drive having high cost and performance, and
when the application is in a state of not accessing the data, the data is stored in the physical drive having low cost and performance compared to the physical drive having high cost and performance.

3. The storage system according to claim 1, wherein
the second storage
includes a first pool, a second pool, and a third pool in the storage pool,
causes the first pool and the second pool to correspond to the physical drive having higher cost and performance than the third pool,
causes the third pool to correspond to the physical drive having lower cost and performance than the first pool and the second pool,
migrates the data stored in the second pool between the physical drive corresponding to the second pool and the physical drive corresponding to the third pool according to a state of an application using the data, and
does not migrate the data stored in the first pool between the plurality of physical drives according to the state of the application using the data.

4. The storage system according to claim 3, wherein
the second storage
reads the data from the first pool, the second pool, or the third pool mapped to the second logical volume and responds to the application in response to the I/O request from the application, and
stores the data in the second pool when the data is read from the third pool.

5. The storage system according to claim 3, wherein
the second storage
stores first data written from the application and second data transferred from the first storage in the storage pool, and
defines a pool in which the first data and the second data are stored from among the first pool, the second pool, and the third pool.

6. The storage system according to claim 5, wherein
the second storage
stores the second data in the second pool, and when the application is in a state of not accessing the data, deletes the second data instead of migrating the second data to the third pool, and
after the application is in a state of accessing the data after deletion of the second data, transfers the deleted second data from the first storage to the second storage and stores the deleted second data in the second pool.

7. The storage system according to claim 3, wherein
the physical drive having low cost and performance corresponding to the third pool is an object storage.

8. A storage system control method to be executed by a storage system including a first storage and a second storage,
each of the first storage and the second storage including
a physical drive configured to physically store data,
a storage pool formed based on a storage area of the physical drive,
a logical volume mapped to the storage pool and provided as a request destination of an I/O request,
a memory, and
a processor,
the first storage including a first logical volume,
the second storage including a second logical volume corresponding to the first logical volume,
the storage system control method comprising:
storing, by the second storage, the data in the storage pool correspondingly to the plurality of physical drives having different costs and performance with each other; and
migrating, by the second storage, the data between the plurality of physical drives having different costs and performance according to a state of an application using the data.
